(19) United States
(12) Patent Application Publication
(10) Pub. No.: US 2025/0358662 A1
(43) Pub. Date: Nov. 20, 2025

(54) CORRESPONDENCE BETWEEN BEAM SETS FOR PREDICTIVE BEAM MANAGEMENT

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Arumugam CHENDAMARAI KANNAN, San Diego, CA (US); Tao LUO, San Diego, CA (US)

(21) Appl. No.: 18/874,582

(22) PCT Filed: Aug. 12, 2022
(86) PCT No.: PCT/CN2022/112162

§ 371 Date: Dec. 12, 2024

(51) Int. Cl. H04W 24/10; H04B 7/06; H04B 17/373; H04L 5/00; H04W 72/044; H04W 72/231

(52) U.S. Cl. CPC H04W 24/10; H04B 7/0626; H04B 17/373; H04L 5/0051; H04W 72/046; H04W 72/231

(57) ABSTRACT

Certain aspects relate to correspondence information between beam sets for beam prediction. For example, an apparatus may obtain, from a network entity, a configuration indicating a first set of resources. The apparatus may identify information between the first set of resources and a second set of resources. The apparatus may output, for transmission to the network entity, a channel measurement report indicating one or more predicted channel metrics for at least the second set of resources, wherein the one or more predicted channel metrics are predicted based on the information.

### BACKGROUND

### Technical Field

The present disclosure generally relates to communication systems, and more particularly, to correspondence information between beam sets for predictive beam management.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

There exists a need for further improvements in 5G NR technology. These improvements may also be applicable to other multi-access technologies and the telecommunication standards that employ these technologies. For instance, improvements to efficiency and latency relating to mobility of user equipments (UEs) communicating with network entities are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Certain aspects are directed to a method for wireless communication at a user equipment. In some examples, the method includes obtaining, from a network entity, a configuration indicating a first set of resources. In some examples, the method includes identifying information between the first set of resources and a second set of resources. In some examples, the method includes outputting, for transmission to the network entity, a channel measurement report indicating one or more channel metrics for at least the second set of resources, wherein the one or more channel metrics are predicted based on the information.

Certain aspects are directed to an apparatus configured for wireless communication, comprising a memory comprising instructions and one or more processors configured to execute the instructions. In some examples, the apparatus is configured to obtain, from a network entity, a configuration indicating a first set of resources. In some examples, the apparatus is configured to identify information between the first set of resources and a second set of resources. In some examples, the apparatus is configured to output, for transmission to the network entity, a channel measurement report indicating one or more channel metrics for at least the second set of resources, wherein the one or more channel metrics are predicted based on the information.

Certain aspects are directed to a non-transitory computer-readable medium having instructions stored thereon that, when executed by an apparatus, cause the apparatus to perform operations comprising obtaining, from a network entity, a configuration indicating a first set of resources. In some examples, the operations include identifying correspondence information between the first set of resources and a second set of resources. In some examples, the operations include outputting, for transmission to the network entity, a channel measurement report indicating one or more channel metrics for at least the second set of resources, wherein the one or more channel metrics are predicted based on the information.

Certain aspects are directed to an apparatus for wireless communication. In some examples, the apparatus includes means for obtaining, from a network entity, a configuration indicating a first set of resources. In some examples, the apparatus includes means for identifying correspondence information between the first set of resources and a second set of resources. In some examples, the apparatus includes means for outputting, for transmission to the network entity, a channel measurement report indicating one or more channel metrics for at least the second set of resources, wherein the one or more channel metrics are predicted based on the information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B is a diagram illustrating an example of disaggregated base station architecture, in accordance with various aspects of the present disclosure.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4A is an example of a configuration, in accordance with various aspects of the present disclosure.

FIG. 4B is an example of association between a first set of resources and a second set of resources, in accordance with various aspects of the present disclosure.

FIG. 4C is another example of association between a first set of resources and a second set of resources, in accordance with various aspects of the present disclosure.

FIG. 4D is another example of association between a first set of resources and a second set of resources, in accordance with various aspects of the present disclosure.

FIG. 5A is an example of a configuration, in accordance with various aspects of the present disclosure.

FIG. 5B is an example of association between a first set of resources and a second set of resources, in accordance with various aspects of the present disclosure.

FIG. 5C is another example of association between a first set of resources and a second set of resources, in accordance with various aspects of the present disclosure.

FIG. 6A is an example of a configuration, in accordance with various aspects of the present disclosure.

FIG. 6B is an example of a configuration, in accordance with various aspects of the present disclosure.

FIG. 7 is a diagram illustrating an example of a hardware implementation for an example apparatus.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Existing techniques for beam management and beam prediction can result in significant overhead and can consume significant amount of power due to frequent reception of reference signals and tracking beam and/or channel conditions. Additionally, existing techniques for predicting beams also rely on excessing beam sweepings to accurately predict beams and/or channel metrics for beams. However, excessing beam sweepings can also consume a significant amount of power.

Accordingly, the techniques described herein reduce the overhead and power consumption for the UE for beam management and/or beam prediction and improves accuracy of a beam prediction. In certain aspects, UE may obtain, from a network entity, a configuration indicating a first set of resources. The UE may identify information between the first set of resources and a second set of resources. The UE may output transmission to the network entity, a channel measurement report indicating one or more predicted channel metrics for at least the second set of resources, wherein the one or more predicted channel metrics are predicted based on the information. Additional details of these techniques are described below.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

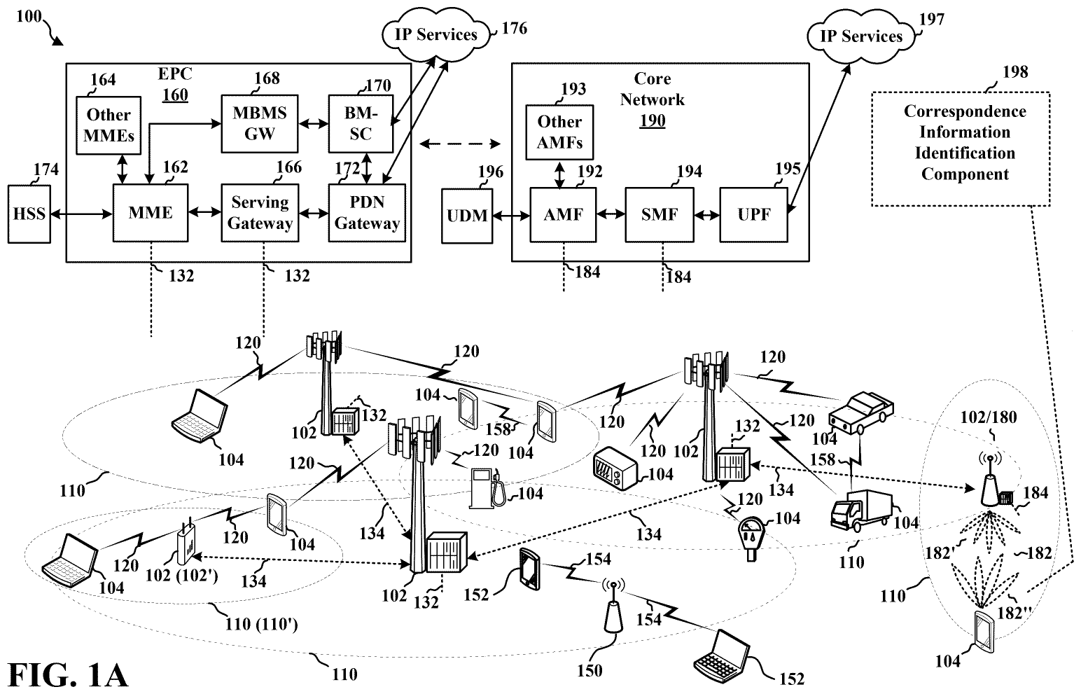

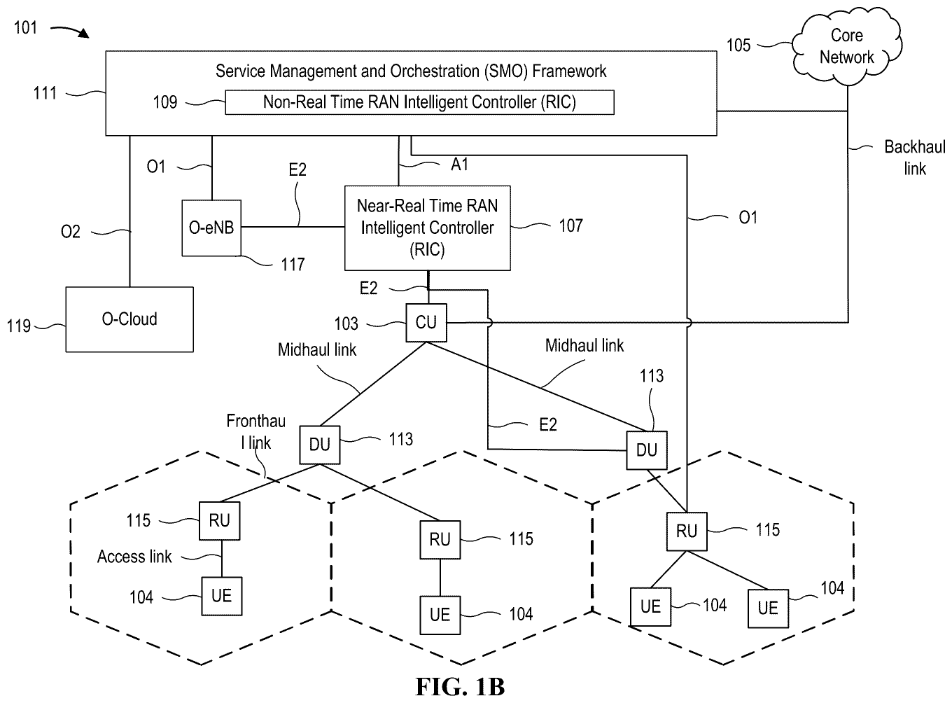

FIG. 1 is a diagram illustrating an example of a wireless communications system 100 (also referred to as a wireless wide area network (WWAN)) that includes base stations 102 (also referred to herein as network entities), user equipment(s) (UE) 104, an Evolved Packet Core (EPC) 160, and another core network 190 (e.g., a 5G Core (5GC)).

One or more of the UE 104 may include correspondence information identification component 198, wherein the correspondence information identification component 198 are operable to perform techniques for identifying correspondence information between a first set of beams and a second set of beams, and improving accuracy of beam prediction while reducing overhead and power consumption for UE.

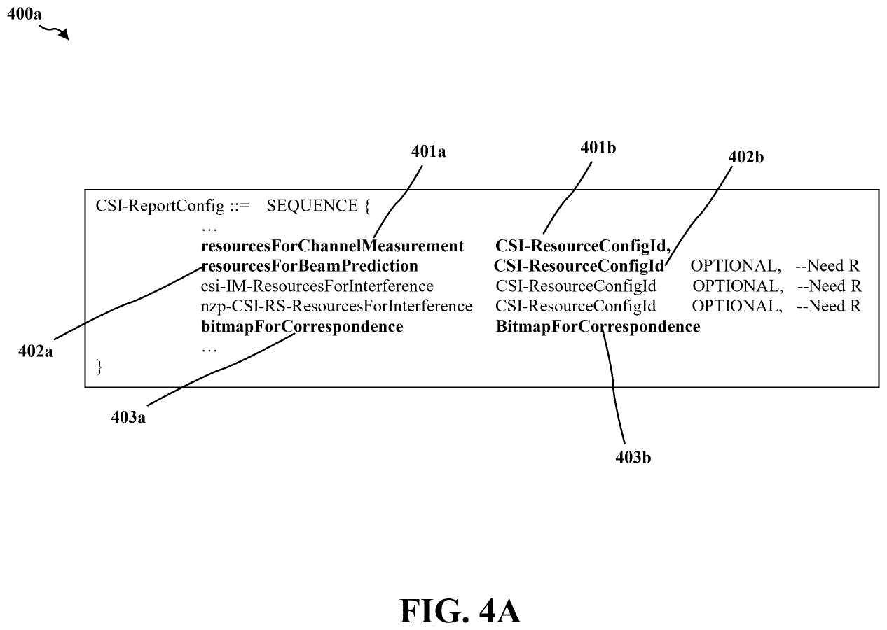

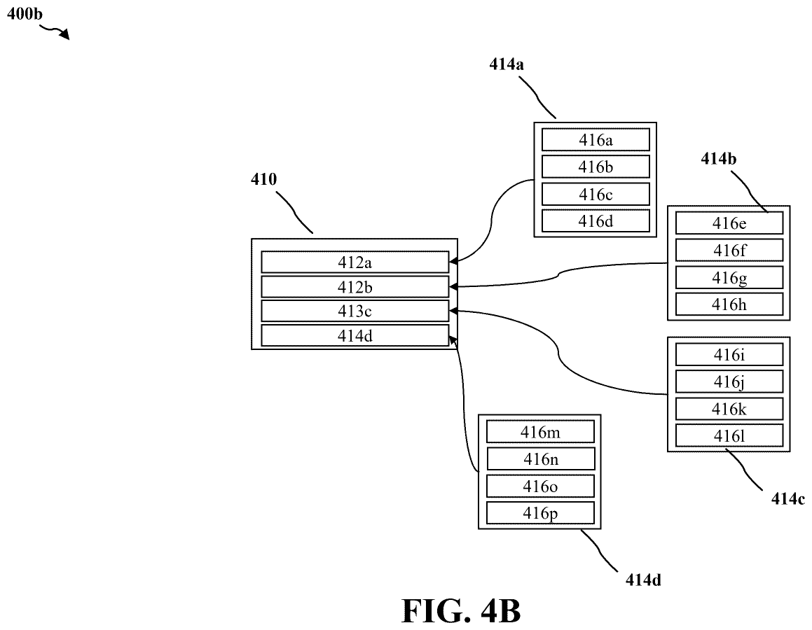

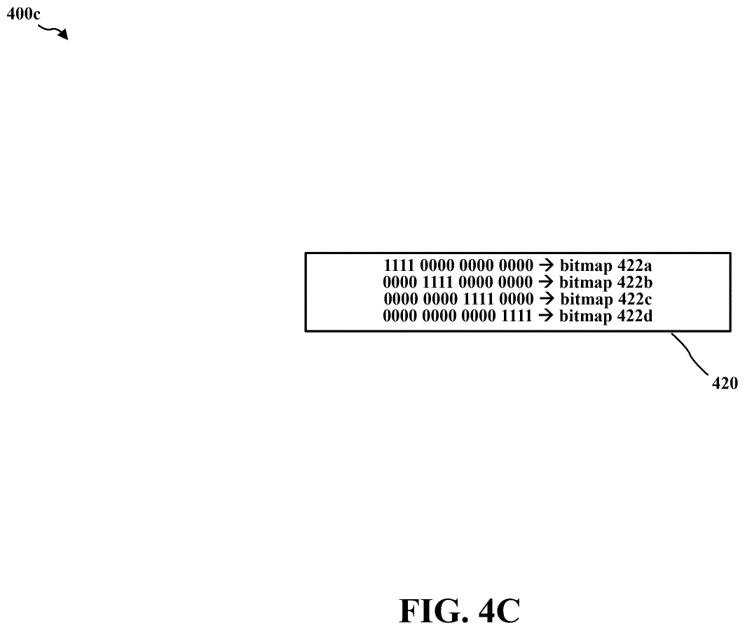

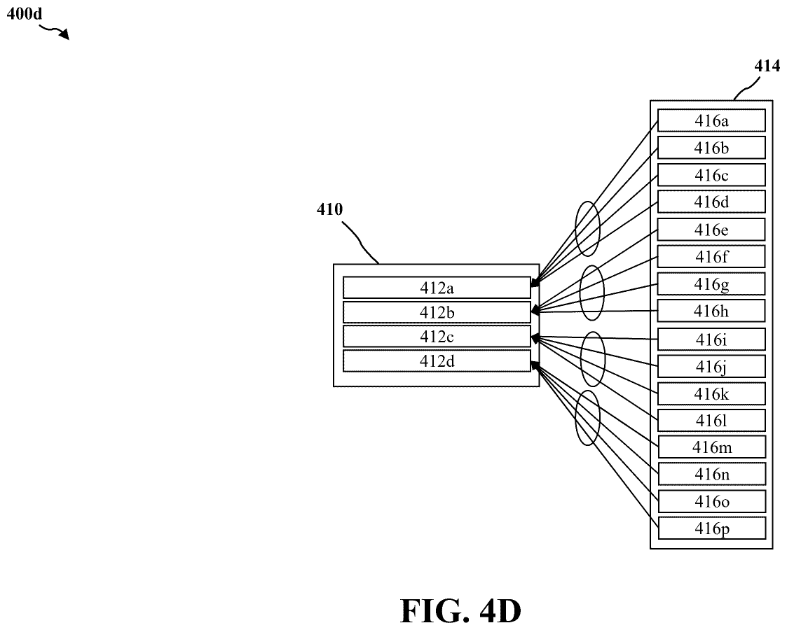

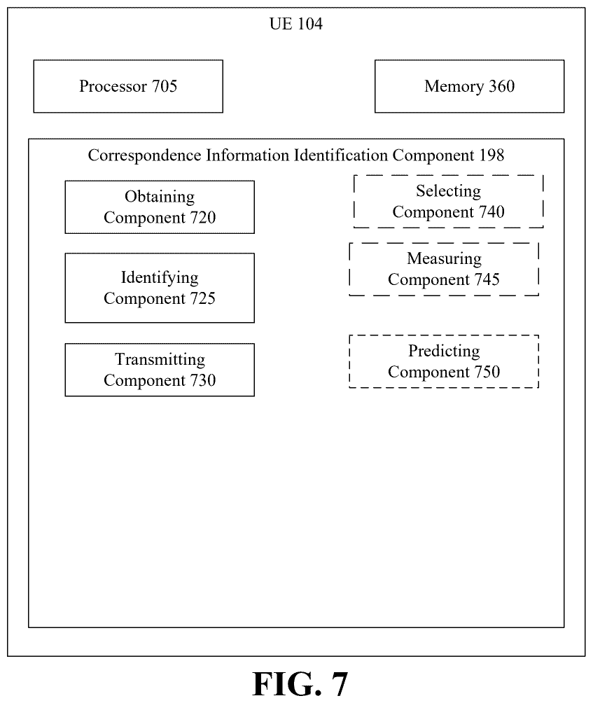

At one or more of the UEs 104, and additionally referring to FIG. 7, the correspondence information identification component 198 includes an obtaining component 720 configured to obtain, from a network entity, a configuration indicating a first set of resources. Further, the correspondence information identification component 198 includes a identifying component 725 configured to identify information between the first set of resources and a second set of resources. Additionally, the correspondence information identification component 198 includes an outputting component 730 configured to output for transmission to the network entity, a channel measurement report indicating one or more predicted channel metrics for at least the second set of resources, wherein the one or more predicted channel metrics are predicted based on the information. Also, in some optional or additional aspects, the correspondence information identification component 198 may include a selecting component 740, measuring component 745, and prediction component 750. Additional details of the obtaining component 720, identifying component 725, outputting component 730, selecting component 740, measuring component 745 prediction component 750 are provided below, for example, with reference to FIGS. 4-13.

The base stations (or network entities) 102 may include macrocells (high power cellular base station) and/or small cells (low power cellular base station). The macrocells include base stations. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). In some aspects, the CUs may be implemented within an edge RAN node, and in some aspects, one or more DUs may be co-located with a CU, or may be geographically distributed throughout one or multiple RAN nodes. The DUs may be implemented to communicate with one or more RUs. Any of the disaggregated components in the D-RAN and/or O-RAN architectures may be referred to herein as a network entity.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a network entity, gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, monitors, cameras, industrial/manufacturing devices, appliances, vehicles, robots, drones, etc.). IoT UEs may include machine type communications (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

FIG. 1B is a diagram illustrating an example of disaggregated base station 101 architecture, any component or element of which may be referred to herein as a network entity. The disaggregated base station 101 architecture may include one or more central units (CUs) 103 that can communicate directly with a core network 105 via a backhaul link, or indirectly with the core network 105 through one or more disaggregated base station units (such as a Near-Real Time (Near-RT) RAN Intelligent Controller (RIC) 107 via an E2 link, or a Non-Real Time (Non-RT) RIC 109 associated with a Service Management and Orchestration (SMO) Framework 111, or both). A CU 103 may communicate with one or more distributed units (DUs) 113 via respective midhaul links, such as an F1 interface. The DUs 113 may communicate with one or more radio units (RUs) 115 via respective fronthaul links. The RUs 115 may communicate with respective UEs 104 via one or more radio frequency (RF) access links. In some implementations, the UE 104 may be simultaneously served by multiple RUs 115.

Each of the units, e.g., the CUS 103, the DUs 113, the RUs 115, as well as the Near-RT RICs 107, the Non-RT RICs 109 and the SMO Framework 111, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 103 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 103. The CU 103 may be configured to handle user plane functionality (i.e., Central Unit-User Plane (CU-UP)), control plane functionality (i.e., Central Unit-Control Plane (CU-CP)), or a combination thereof. In some implementations, the CU 103 can be logically split into one or more CU-UP units and one or more CU-CP units. The CU-UP unit can communicate bidirectionally with the CU-CP unit via an interface, such as the E1 interface when implemented in an O-RAN configuration. The CU 103 can be implemented to communicate with the DU 113, as necessary, for network control and signaling.

The DU 113 may correspond to a logical unit that includes one or more base station functions to control the operation of one or more RUs 115. In some aspects, the DU 113 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 113 may further host one or more low PHY layers. Each layer (or module) can be implemented with an interface configured to communicate signals with other layers (and modules) hosted by the DU 113, or with the control functions hosted by the CU 103.

Lower-layer functionality can be implemented by one or more RUs 115. In some deployments, an RU 115, controlled by a DU 113, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 115 can be implemented to handle over the air (OTA) communication with one or more UEs 104. In some implementations, real-time and non-real-time aspects of control and user plane communication with the RU(s) 115 can be controlled by the corresponding DU 113. In some scenarios, this configuration can enable the DU(s) 113 and the CU 103 to be implemented in a cloud-based RAN architecture, such as a vRAN architecture.

The SMO Framework 111 may be configured to support RAN deployment and provisioning of non-virtualized and virtualized network elements. For non-virtualized network elements, the SMO Framework 111 may be configured to support the deployment of dedicated physical resources for RAN coverage requirements which may be managed via an operations and maintenance interface (such as an O1 interface). For virtualized network elements, the SMO Framework 111 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 103, DUs 113, RUs 115 and Near-RT RICs 107. In some implementations, the SMO Framework 111 can communicate with a hardware aspect of a 4G RAN, such as an open eNB (O-eNB) 117, via an O1 interface. Additionally, in some implementations, the SMO Framework 111 can communicate directly with one or more RUs 115 via an O1 interface. The SMO Framework 111 also may include a Non-RT RIC 109 configured to support functionality of the SMO Framework 111.

The Non-RT RIC 109 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 107. The Non-RT RIC 109 may be coupled to or communicate with (such as via an A1 interface) the Near-RT RIC 107. The Near-RT RIC 107 may be configured to include a logical function that enables near-real-time control and optimization of RAN elements and resources via data collection and actions over an interface (such as via an E2 interface) connecting one or more CUs 103, one or more DUs 113, or both, as well as an O-eNB, with the Near-RT RIC 107.

In some implementations, to generate AI/ML models to be deployed in the Near-RT RIC 107, the Non-RT RIC 109 may receive parameters or external enrichment information from external servers. Such information may be utilized by the Near-RT RIC 107 and may be received at the SMO Framework 111 or the Non-RT RIC 109 from non-network data sources or from network functions. In some examples, the Non-RT RIC 109 or the Near-RT RIC 107 may be configured to tune RAN behavior or performance. For example, the Non-RT RIC 109 may monitor long-term trends and patterns for performance and employ AI/ML models to perform corrective actions through the SMO Framework 111 (such as reconfiguration via O1) or via creation of RAN management policies (such as A1 policies).

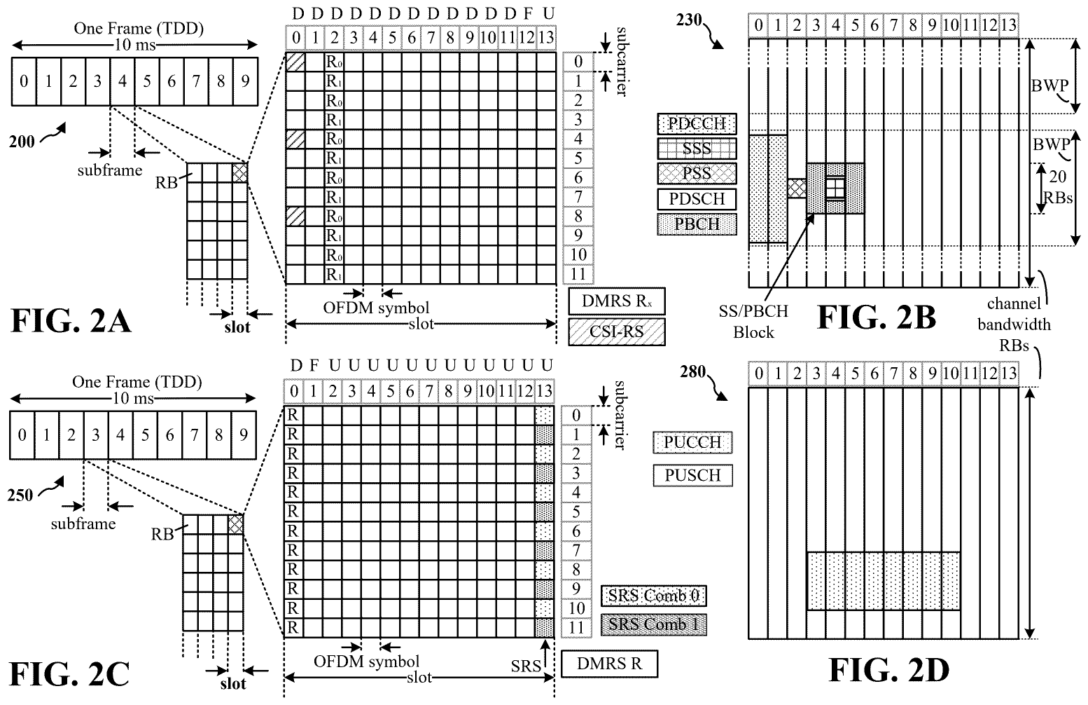

FIGS. 2A-2D are diagrams of various frame structures, resources, and channels used by UEs 104 and base stations 102/180 for communication. FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to kilohertz (kHz), where is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

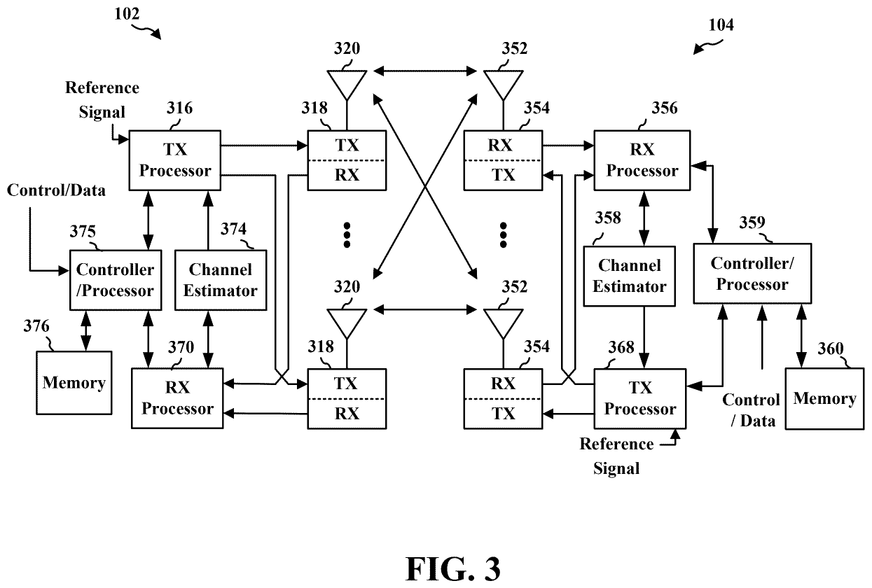

FIG. 3 is a block diagram of hardware components of the base station 102 (or 180) in communication with the UE 104 in the wireless communication network 100. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 104. Each spatial stream may then be provided to a different antenna 320 via a separate transmitter 318TX. Each transmitter 318TX may modulate an RF carrier with a respective spatial stream for transmission.

At the UE 104, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 104. If multiple spatial streams are destined for the UE 104, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 102. These soft decisions may be based on channel estimates computed by the channel estimator 358. The soft decisions are then decoded and deinterleaved to recover the data and control signals that were originally transmitted by the base station 102 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 102, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 102 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 102 in a manner similar to that described in connection with the receiver function at the UE 104. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 104. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1. For example, the memory 360 may include executable instructions defining the correspondence information identification component 198. The TX processor 368, the RX processor 356, and/or the controller/processor 359 may be configured to execute the correspondence information identification component 198.

As described above, existing techniques for beam prediction or predictive beam management may consume significant power resources or result in large resource overhead to achieve accurate beam predictions that satisfy latency and/or throughput requirements for data transmission via the predicted beams.

The techniques described herein can improve accuracy of beam prediction for beam management while reducing overhead and power consumption for the UE. In accordance with the aspects described herein, the UE 104 may receive a configuration. The configuration may be associated with a channel measurement report. For example, the configuration may be associated a CSI report. The configuration may indicate at least a set of channel measurement resources (CMRs). Examples of CMRs may be a set downlink reference signals (DL-RSs), such as SSBs, CSI-RSs, and the like. The UE 104 may be configured to determine one or more channel metrics for the CMRs. Examples of channel metrics may include, but are not limited to, a reference signal received power (RSRP), a reference signal received quality (RSRQ), a sounding reference signal (SRS), a received signal strength indicator (RSSI), or a signal-to-noise and interference (SINR) ratio, and the like.

The UE 104 may predict one or more channel metrics for a second set of resources based on correspondence information between the CMRs and the second set or resources and one or more channel metrics of the CMRs. In some implementations, the second set of resources may be a set of channel prediction resources (CPRs), or another set or subset of CMRs. In some implementations, CPRs may be a set of DL-RSs. In some implementations, at least one or more resources of the second set of resources may not be transmitted to the UE 104. In some implementations, the second set of resources may be a set of nominal DL-RS, where the network entity 102/180 may not transmit the second set of resources.

The UE 104 may be configured to identify the CMRs and the second set of resources based on signaling associated with one or more channel measurement reports, such as configurations for channel measurement reports received via RRC, MAC-CE, DCI, and the like. For example, the UE 104 may be configured with a periodic (P) CSI report and receive a report configuration (e.g., CSI-ReportConfig) via an RRC message. Similarly, the UE 104 may receive an activation for a semi-persistent (SP) CSI report and receive a report configuration via MAC-CE message, or may be triggered for aperiodic (AP) CSI report, and receive a triggering configuration via a DCI message.

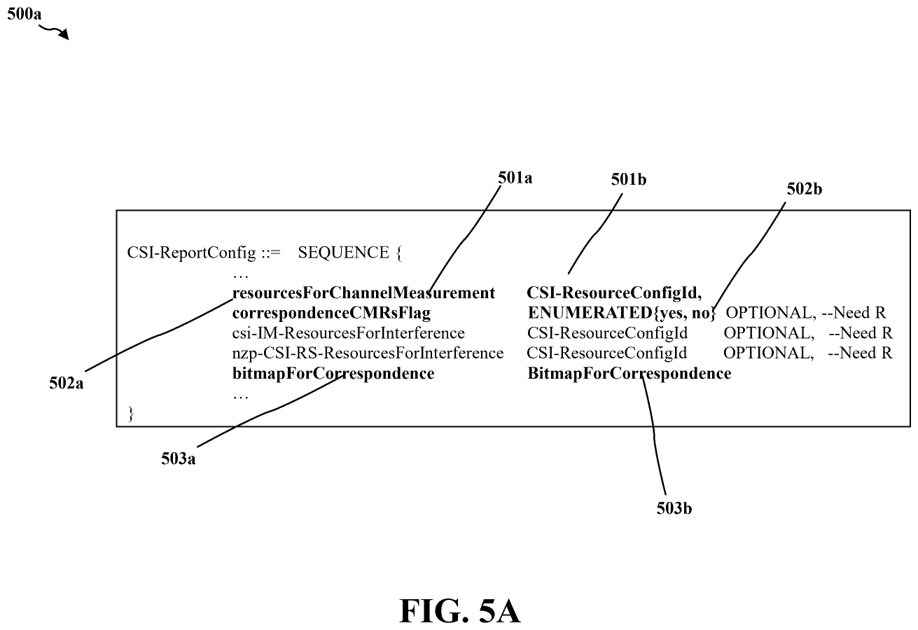

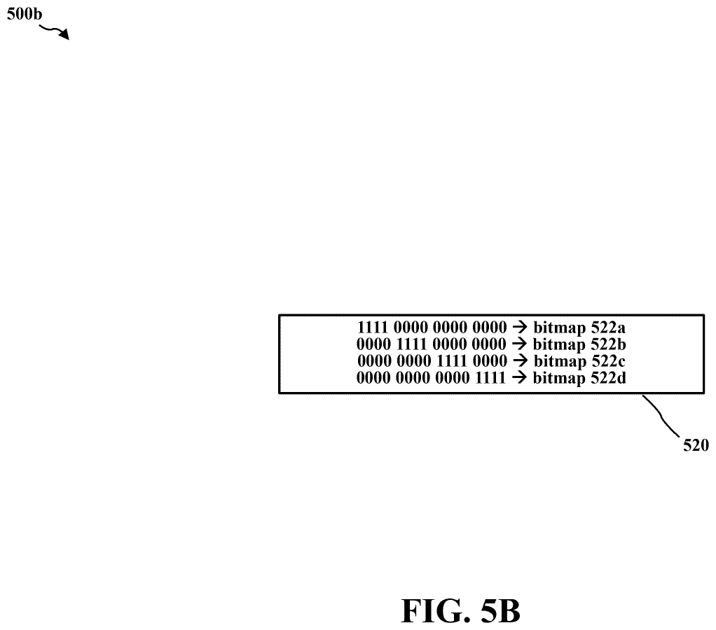

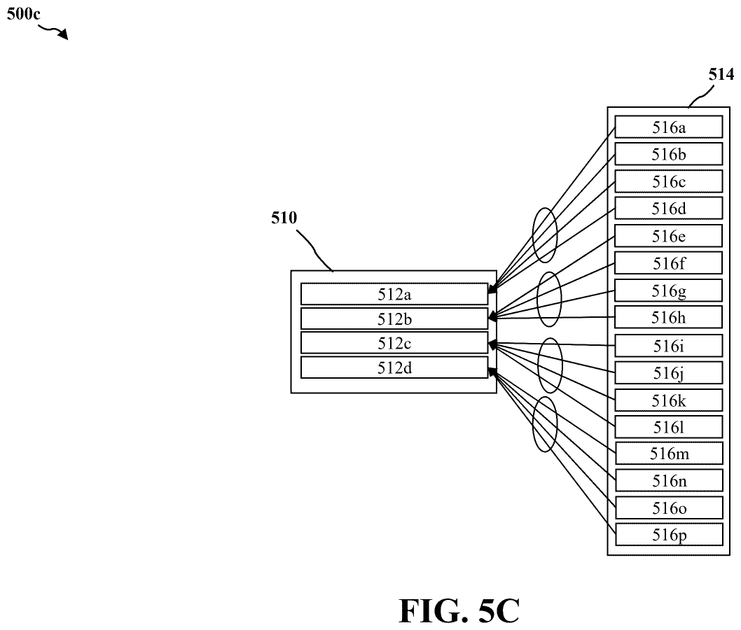

The UE 104 may be configured to identify correspondence information between the set of CMRs and the second set of resources based on the above described signaling associated with one or more channel measurement reports, such as configurations for channel measurement reports received via RRC, MAC-CE, DCI, and the like. In some implementations, the UE 104 may be configured to identify the correspondence information between the CMRs and the second set of resources based on the signaling associated with one or more sets of resources indicated in the signaling associated with channel measurement reports. Examples, of signaling associated with the different sets of resources may be CSI resource configurations (CSI-ResourceConfig) for SSBs, periodic CSI-RS, SP CSI-RS, and the like, received via RRC message. Similarly, signaling associated with the different sets of resources may be CSI resource configurations for SP CSI-RSs, received via MAC-CE, and/or CSI resource configurations for AP CSI-RS, received via DCI. Additional details of identifying CMRs and the second set of resources, the correspondence information between the CMRs and the second set of resources, and the signaling associated with one or more channel measurement reports, the CMRs and the second set of resources are described herein with respect to FIGS. 4A-5C

Referring to FIG. 4A, in some implementations, a UE 104 may receive a configuration 400a from a network entity 102/180. As described above, configurations received from the network entity 102/180 may be associated with a channel measurement report, such as a CSI report, as shown by configuration 400a. The configuration 400a may indicate a set of CMRs (e.g., a first group of DL-RS) via information elements 401a and 401b. The configuration 400a may indicate a set of CPRs via information elements 402a and 402b. As described above, the set of CPRs may be a set of reference signals (e.g., DL-RSs), and in some implementations, at least one of the resources of the CPRs may not be transmitted to the UE 104. For example, the network entity 102/180 may not transmit at least one of the reference signals from the set of CPRs.

The UE 104 may be configured to identify the CMRs and the CPRs based on the configuration 400a. For example, the UE 104 may identify the resources that are part of the CMR set based on the resources indicated by the information elements 401a and 401b, and similarly, the UE 104 may identify the resources that are part of the CPR set based on the resources indicated by the information elements 402a and 402b. The indicated resources of the CMR set may be a set of reference signals (e.g., DL-RS), and the UE 104 may identify them as a first group of reference signals (e.g., DL-RS). The indicated resources of the CPR set may be a set of reference signals (e.g., DL-RS), and the UE 104 may identify them as a second group of reference signals (e.g., DL-RS).

In some implementations, one or more resources of the set of CPRs may be nominal resources that are not transmitted to the UE 104. For example, one or more resources of the set of CPRs may be nominal reference signals that are not transmitted to the UE 104. Identifiers of such resources may be indicated via a configuration (e.g., configuration 400a) received by the UE 104. For example, the identifiers of these resources may be indicated by the information elements 402a and 402b, and the UE 104 may obtain these identifiers based on the indication from these information elements and/or the resource configuration indicated by these information elements.

While the UE 104 may not receive one or more resources of the CPRs, the UE 104 may be configured to predict one or more channel metrics for these resources and indicate them in the channel measurement report generated and transmitted to the network entity 102/180.

The UE 104 may be configured with a set of rules that indicate and/or specify correspondence information between the CMRs (e.g., first group of reference signals) and the CPRs (e.g., second group of reference signals). As described herein, in some implementations, the correspondence information between two resources (e.g., reference signals, DL-RSs, and the like) may indicate a beam shape, a beam width, a beam pointing direction, and/or other similar information of a first resource (e.g., a reference signal, a DL-RS, and the like) relative to a second resource (e.g., a reference signal, a DL-RS, and the like). The UE 104 may identify the correspondence information between the CMRs and the CPRs based on the set of rules. For example, the UE 104 may be configured with a set of rules that indicate that beam widths for a subset of resources of the CPRs may be within a beam width of a resource in the CMRs. As described herein, in some implementations, beam width may be the angular spread of the beam with less than 3 dB power degradation from its power's angular direction). Similarly, the set of rules may indicate beam shape, beam pointing direction information, and/or other similar information for the subset of resources in the CPRs relative to a resource in the CMRs.

In some implementations, a first subset of CPRs indicated in the configuration 400a may be predefined and/or defined to comprise beam shape, beam width, beam pointing direction, and/or the like, relative to a first resources of the CMRs indicated in the configuration 400a. Similarly a second subset of CPRs indicated in the configuration 400a may be predefined and/or defined to comprise beam shape, beam width, beam pointing direction, and/or the like, relative to a second resource of CMRs indicated in the configuration 400a, and so on. For example, in some implementations, if X CMRs (e.g., DL-RSs) are indicated in the configuration 400a, then a first subset of resources of the CPRs indicated in the configuration 400a may be predefined and/or defined to comprise beam widths within a beam width of a first resource of the X CMRs, a second subset of CPRs may be predefined and/or defined to comprise beam widths within a beam width of a second CMR resource, a third subset of CPRs may be predefined and/or defined to comprise beam widths within a beam width of a third CMR resource, and similarly, an Xth subset of CPRs may be predefined and/or defined to comprise beam widths within a beam width of an X CMR resource.

The UE 104 may be configured to identify the correspondence information between the different subsets of resources of the CPRs and the different resources of CMRs. In some implementations, the UE 104 may be configured with a set of rules and/or instructions that indicate or specify that beam shapes, beam widths, beam pointing directions, and the like, of a first subset of resources of the CPRs are relative to a first resource of CMRs, and may similarly indicate and/or specify that beam shapes, beam widths, beam pointing directions, and the like, of a second subset of resources of CPRs are relative to a second resource of CMRs, and so on. An example of UE 104 configured to identify correspondence information between a subset of resources of CPRs and a resource of CMR will be described herein with reference to FIG. 4B.

Referring to FIG. 4B, the set of CMRs 410 are indicated via information elements 401a and 401b of configuration 400a of FIG. 4A. The set of CMRs may include multiple resources (e.g., DL-RS), such as SSB, and the like. As shown in FIG. 4B, the set of CMRs 410 include resources 412a, 412b, 412c, 412d. As described above, the set of CPRs are indicated via information elements 402a and 402b in configuration 400a. The subsets of CPRs 414a, 414b, 414c, 414d, collectively referred to herein as subsets of CPRs 414, are subsets of the set of CPRs indicated via information elements 402a and 402b in the configuration 400a. In some implementations, the subset of CPRs 414 may include multiple CPR resources as shown in FIG. 4B.

For example, as shown in FIG. subset of CPRs 414a may include CPRs 416a, 416b, 416c, 416d, subset of CPRs 414b may include CPRs 416e, 416f, 416g, 416h, subset of CPRs 414c may include CPRs 416i, 416j, 416k, 416l, and subset of CPRs 414d may include CPRs 416m, 416n, 416o, 416p.

The UE 104, based on the configured rules, may identify correspondence information between CMR 412a and the subset of CPRs 414a by identifying, based on the configured rules, a beam width, a beam shape, a beam pointing direction, and/or the like of CPRs 416a, 416b, 416c, and/or 416d relative to the beam width, the beam shape, and/or the beam pointing direction of CMR 412a. For example, the configured rules may indicate and/or specify that beam widths of a first subset of CPRs are within a first CMR, beam widths of a second subset of CPRs are within a second CMR, beam widths of a third subset of CPRs are within a third CMR, beam widths of a fourth subset of CPRs are within a fourth CMR, and so on. Continuing with the example, based on the configured rules, the UE 104 may identify that the beam widths of CPRs 416a, 416b, 416c, 416d, are within the beam width of CMR 412a, the beam widths of CPRs 416e, 416f, 416g, 416h, are within the beam width of CMR 412b, the beam widths of CPRs 416i, 416j, 416k, 416l, are within the beam width of CMR 412c, the beam widths of CPRs 416m, 416n, 416o, 416p, are within the beam width of CMR 412d.

Referring back to FIG. 4A, in some implementations, the configuration 400a may indicate a bitmap (e.g., via information elements 403a and 403b) for identifying correspondence information between a CPR and a CMR. An example of such a bitmap is shown in FIG. 4C.

Referring to example 400d of FIG. 4C, a set of bitmaps 420 may indicate a mapping between one or more CPRs of the set of CPRs 412 indicated by information elements 402a and 402b and a CMR of the set of CMRs 410 indicated by information elements 401a and 401b. In some implementations, the set of bitmaps 420 may include a bitmap of length Y for each CMR in the set of X CMRs 410. For example, as shown in FIG. 4C, bitmap 422a is for and/or associated with CMR 412a in the set of CMRs 410, bitmap 422b is for and/or associated with CMR 412b in the set of CMRs 410, bitmap 422c is for and/or associated with CMR 412c in the set of CMRs 410, bitmap 422d is for and/or associated with CMR 412d in the set of CMRs 410.

In some implementations, the length Y of the bitmap may be based on the number of CPRs indicated via the information elements 402a and 402b of configuration 400a. For example, length of bitmaps 422a, 422b, 422c, 422d, is 16 bits, where each bit is associated with a respective CPR in the set of CPRs 414 (e.g., CPRs 416a, 416b, 416c, 416d, 416e, 416f, 416g, 416h, 416i, 416j, 416k, 416l, 416m, 416n, 416o, 416p).

The UE 104 may be configured to identify one or more CPRs for each CMR based on a corresponding bitmap in the set of bitmaps 420. For example, the UE 104 may identify that CPRs 416a, 416b, 416c, 416d are associated with CMR 412a. The UE 104 may be further configured to identify the correspondence information between the associated CPRs and the CMR. For example, the UE 104 may be configured with one or more sets of rules and/or instructions that specify or indicate that a beam shape, a beam width, a beam pointing direction, and/or the like of an associated CPR relative to a beam shape, a beam width, a beam pointing direction, and/or the like of the CMR. For example, a set of rules and/or instructions may indicate that for every high bit in a bitmap, a corresponding CPR's beam width is within a beam width of the CMR of and/or associated with the bitmap, and based on the bitmap 422a, the UE 104 may determine that the beam widths of CPRs 416a is within the beam width of 412a. Similarly, the UE 104 may determine that the beam width of CPR 416b is within the beam width of 412a, the beam width of 416c is within the beam width of 412a, and the beam width of 416d is within the beam width of 412a.

Referring to example 400d of FIG. 4D, in some implementations, the UE 104 may be configured to determine that a TypeD-quasi co-located (TypeD-QCL) source reference signal of a CPR in set of CPRs 412 is at least one of the CMRs in the set of CMRs 410 and/or a reference signal received over that CMR. The UE 104 may be configured to identify correspondence information between the CPR and the CMR are based on TypeD-QCL relationship between the CPR and the CMR. As described above, the UE may be configured with one or more rules and/or instructions to associate a certain number of CPRs in the set of CPRs 412 with a CMR in the set of CMRs 410. For example, based on the one or more rules and/or instructions, the UE 104 may be configured to associate the first four CPR identifiers (e.g., reference signal identifiers) indicated in the set of CPRs 412 with the first CMR identifier (e.g., reference signal identifier) indicated in the set of CMRs 410, the second four indicated CPR identifiers with a second indicated CMR, and so on. For example, the UE 104 may be configured to associate CPRs 416a, 416b, 416c, 416d, with CMR 412a, CPRs 416e, 416f, 416g, 416h, with CMR 412b, CPRs 416i, 416j, 416k, 416l, with CMR 412c, CPRs 416m, 416n, 416o, 416p, with CMR 412d.

The UE 104 may identify the correspondence information between CMR 412a and CPRs 416a, 416b, 416c, 416d based on the TypeD-QCL reference signal received over CMR 412a, the correspondence information between CMR 412b and CPRs 416e, 416f, 416g, 416h based on the TypeD-QCL reference signal received over CMR 412b, the correspondence information between CMR 412c and CPRs 416i, 416j, 416k, 416l based on the TypeD-QCL reference signal received over CMR 412c, the correspondence information between CMR 412d and CPRs 416m, 416n, 416o, 416p based on the TypeD-QCL reference signal received over CMR 412d. For example, the UE 104 may identify a beam width, a beam shape, and/or a beam pointing direction of each of CPRs 416a, 416b, 416c, 416d relative to a beam width, a beam shape, and/or a beam pointing direction of CMR 412a. Similarly, the UE 104 may identify a beam width, a beam shape, and/or a beam pointing direction of each of CPRs 416e, 416f, 416g, 416h relative to a beam width, a beam shape, and/or a beam pointing direction of CMR 412b, and identify a beam width, a beam shape, and/or a beam pointing direction of each of CPRs 416i, 416j, 416k, 416l relative to a beam width, a beam shape, and/or a beam pointing direction of CMR 412c, and identify a beam width, a beam shape, and/or a beam pointing direction of each of CPRs 416m, 416n, 416o, 416p relative to a beam width, a beam shape, and/or a beam pointing direction of CMR 412d.

Referring to FIG. 5A, in some implementations, a UE 104 may receive a configuration with multiple sets of CMRs, and the UE 104 may be configured to measure channel metrics on a first set of the CMRs and predict channel metrics for a second set of CMRs based on the correspondence information between the first set and the second set. For example, as shown in FIG. 5A, the UE 104 may receive a configuration 500a from a network entity 102/180. As described above, configurations received from the network entity 102/180 may be associated with a channel measurement report, such as a CSI report, as shown by configuration 500a. The configuration 500a may indicate multiple sets of CMRs via information elements 501a and 501b. For example, the information elements 501a may indicate to first set of CMRs 510 and a second set of CMRs 514. The configuration 500a may include an indicator and/or a flag indicated via information elements 502a and 502b. The UE 104 may be configured to determine to select the first set of the CMRs 510 for measuring channel metrics and select the second set of CMRs 514 for which to predict channel metrics when the value (indicated by information element 502b) of the indicator and/or the flag indicated by the information element 502a is enabled. The UE 104 may determine that the indicator and/or the flag is enabled based the value indicated by the information element 502b.

The UE may be similarly configured to determine the associations between one or more CMRs of the set of CMRs 514 and a CMR of the set of CMRs 510 similar to how the UE determined associations between the CMRs 410 and the CPRs 412, and similarly identify the correspondence information between the one or more CMRs of the set of CMRs 514 and a CMR of the set of CMRs 510 based on a bitmap, as shown in FIG. 5B, and/or a TypeD-QCL relationship between the CMRs, as shown in FIG. 5C.

In some implementations, the configuration 500b may indicate one or more bitmaps (e.g., via information elements 503a and 503b) for identifying correspondence information between a CMR of set of CMRs 510 and a CMR of set of CMRs 514. As shown in FIG. 5C. the set of bitmaps 520 may indicate a mapping between one or more CMRs of the set of CMRs 514 indicated by information elements 501a and 501b and a CMR of the set of CMRs 510 indicated by information elements 501a and 501b. In some implementations, the set of bitmaps 520 may include a bitmap of length Y for each CMR in the set of X CMRs 510b. For example, as shown in FIG. 5C, bitmap 522a is for and/or associated with CMR 512a in the set of CMRs 510, bitmap 422b is for and/or associated with CMR 512b in the set of CMRs 510, bitmap 422c is for and/or associated with CMR 512c in the set of CMRs 510, bitmap 422d is for and/or associated with CMR 512d in the set of CMRs 510.

In some implementations, the length Y of the bitmap may be based on the number of CMRs of the set of CMRs 514 indicated via the information elements 501a and 501b of configuration 500a. For example, length of bitmaps 522a, 522b, 522c, 522d, is 16 bits, where each bit is associated with a respective CMR in the set of CMRs 514 (e.g., CMRs 516a, 516b, 516c, 516d, 516e, 516f, 516g, 516h, 516i, 516j, 516k, 516l, 516m, 516n, 516o, 516p).

The UE 104 may be configured to identify one or more CMRs in the set of CMRs 514 for each CMR of the set of CMRs 510 based on a corresponding bitmap in the set of bitmaps 520. For example, the UE 104 may identify that CMRs 516a, 516b, 516c, 516d are associated with CMR 512a. The UE 104 may be further configured to identify the correspondence information between the associated CMRs of the set of CMRs 514 and the CMR of the set of CMRs 510. For example, the UE 104 may be configured with one or more sets of rules and/or instructions that specify or indicate that a beam shape, a beam width, a beam pointing direction, and/or the like of an associated CMR of the set of CMRs 514 relative to a beam shape, a beam width, a beam pointing direction, and/or the like of the CMR of the set of CMRs 510. For example, a set of rules and/or instructions may indicate that for every high bit in a bitmap, a corresponding CMR's beam width is within a beam width of the CMR of and/or associated with the bitmap, and based on the bitmap 522a, the UE 104 may determine that the beam width of CMR 516a is within the beam width of CMR 512a. Similarly, the UE 104 may determine that the beam width of 516b is within the beam width of 512a, the beam width of 516c is within the beam width of 512a, and the beam width of 516d is within the beam width of 512a.

In some implementations, the set of bitmaps 520 may be configured in a resource configuration, such as enhanced CSI resource setting (e.g., NZP-CSI-RS-ResourceSet), or CSI-RS/SSB resource set configuration (e.g., CSI_-SSB=ResourceSet).

Referring to example 500d of FIG. 5C, in some implementations, the UE 104 may be configured to determine that a TypeD-quasi co-located (TypeD-QCL) source reference signal of a CMR in set of CMRs 514 is at least one of the CMRs in the set of CMRs 410 and/or a reference signal received over that CMR. The UE 104 may be configured to identify correspondence information between the CMR in set of CMRs 514 and the CMR in set of CMRs 510 are based on TypeD-QCL relationship between the CMR and the CMR. As described above, the UE may be configured with one or more rules and/or instructions to associate a certain number of CMRs in the set of CMRs 514 with a CMR in the set of CMRs 510. For example, based on the one or more rules and/or instructions, the UE 104 may be configured to associate the first four CMR identifiers (e.g., reference signal identifiers) indicated in the set of CMRs 514 with the first CMR identifier (e.g., reference signal identifier) indicated in the set of CMRs 510, the second four indicated CMR identifiers indicated in the set of CMRs 514 with a second indicated CMR indicated in the set of CMRs 510, and so on. For example, the UE 104 may be configured to associate CMRs 516a, 516b, 516c, 516d of the set of CMRs 514, with CMR 512a of the set of CMRs 510, CMRs 516e, 516f, 516g, 516h of the set of CMRs 514, with CMR 512b of the set of CMRs 510, CMRs 516i, 516j, 516k, 516l of the set of CMRs 514, with CMR 512c of the set of CMRs 510, CMRs 516m, 516n, 516o, 516p of the set of CMRs 514, with CMR 512d of the set of CMRs 510.

The UE 104 may identify the correspondence information between CMR 512a and CMRs 516a, 516b, 516c, 516d based on the TypeD-QCL reference signal received over CMR 512a, the correspondence information between CMR 512b and CPRs 516e, 516f, 516g, 516h based on the TypeD-QCL reference signal received over CMR 512b, the correspondence information between CMR 512c and CMRs 516i, 516j, 516k, 516l based on the TypeD-QCL reference signal received over CMR 512c, the correspondence information between CMR 512d and CMRs 516m, 516n, 516o, 516p based on the TypeD-QCL reference signal received over CMR 512d. For example, the UE 104 may identify a beam width, a beam shape, and/or a beam pointing direction of each of CMRs 516a, 516b, 516c, 516d relative to a beam width, a beam shape, and/or a beam pointing direction of CMR 512a. Similarly, the UE 104 may identify a beam width, a beam shape, and/or a beam pointing direction of each of CMRs 516e, 516f, 516g, 516h relative to a beam width, a beam shape, and/or a beam pointing direction of CMR 512b, and identify a beam width, a beam shape, and/or a beam pointing direction of each of CMRs 516i, 516j, 516k, 516l relative to a beam width, a beam shape, and/or a beam pointing direction of CMR 512c, and identify a beam width, a beam shape, and/or a beam pointing direction of each of CMRs 516m, 516n, 516o, 516p relative to a beam width, a beam shape, and/or a beam pointing direction of CMR 512d.

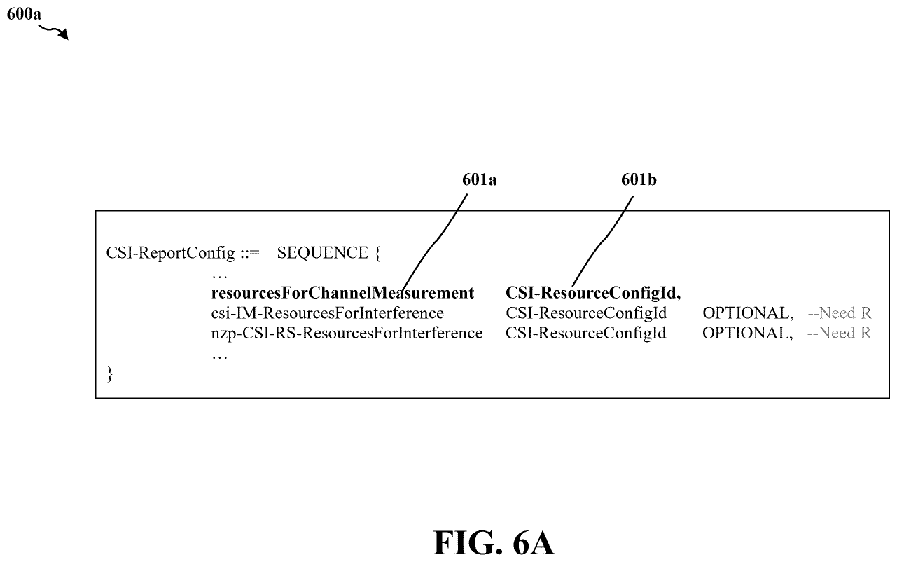

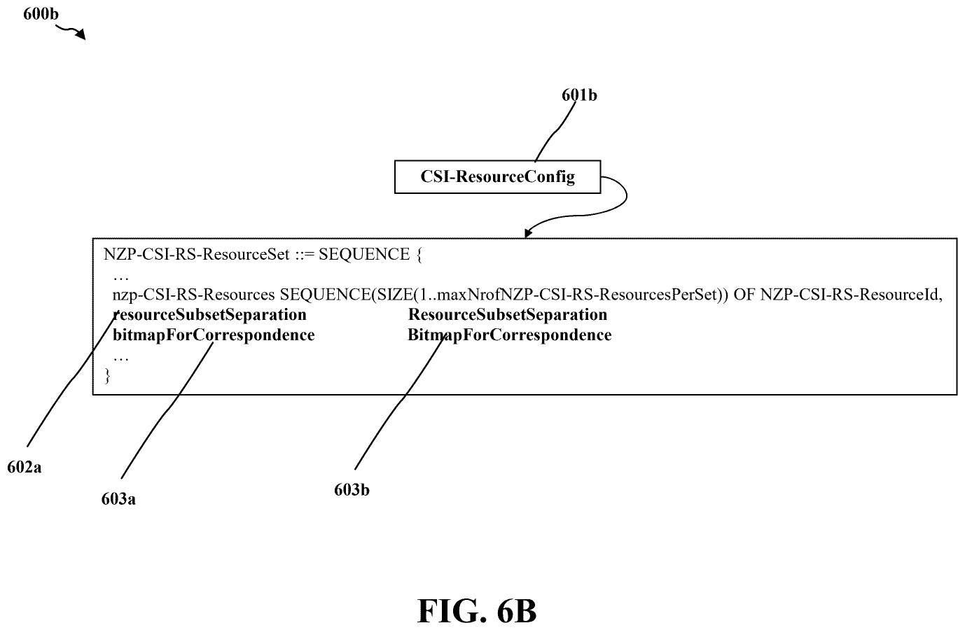

Referring to FIG. 6A, in some implementations, a UE 104 may receive a report configuration indicating one set of CMRs. The UE 104 may receive resource configurations, such as enhanced resource configurations, enhanced CSI-RS/SSB resource set configurations, and/or the like, that indicate subsets of CMRs indicated in the report configuration. The UE 104 may be configured to measure channel metrics on a first subset of the CMRs and predict channel metrics for a second subset of CMRs based on the correspondence information between the first subset and the second subset.

For example, as shown in FIG. 6A, the UE 104 may receive a configuration 600a from a network entity 102/180. As described above, configurations received from the network entity 102/180 may be associated with a channel measurement report, such as a CSI report, as shown by configuration 600a. The configuration 600a may indicate a single set of CMRs via information elements 601a and 601b. Information element 601b indicates a resource configuration (e.g., enhanced resource configurations, enhanced CSI-RS/SSB resource set configurations, and/or the like). An example of such a resource configuration is shown in FIG. 6B. In FIG. 6B, the configuration 600b may indicate a resource identifier (e.g., a reference signal identifier, a CSI-RS identifier, and/or the like), indicated via information elements 602a and 602b.

The UE 104 may be configured to determine how to split the single set of CMRs indicated by the configuration 600a based on the resource identifier indicated in the configuration 600b. For example, the UE 104 may be configured to determine that all resources or resource identifiers indicated by the configuration 600a before and including the resource identifier indicated in the configuration 600b are CMRs (first subset of CMRs) for which the UE 104 measures one or more channel metrics, and the UE 104 may be configured to determine that all resources or resource identifiers indicated by the configuration 600a after and excluding the resource identifier indicated in the configuration 600b are CMRs (second subset of CMRs) for which the UE 104 predicts one or more channel metrics.

The UE 104 may be similarly configured to determine the associations between one or more CMRs of the second subset of CMRs and a CMR of the first subset of CMRs as described above. In some implementations, the UE 104 may be configured to identify the correspondence information between the one or more CMRs of the second subset of CMRs and a CMR of the first subset of CMRs based on one or more bitmaps indicated in via information elements 603a and 603b in the configuration 600b. The UE 104 may be configured to identify the correspondence information similarly as described above in FIGS. 5B and 5C. In some implementations, the UE 104 may be configured to identify the correspondence information between the one or more CMRs of the second subset of CMRs and a CMR of the first subset of CMRs based on a TypeD-QCL relationship between the CMRs. The UE 104 may be configured to identify such correspondence information as described above with respect to FIG. 5C.

Based on the identified correspondence information, the UE 104 may be configured to select a machine learning model from one or more machine models the UE 104 is configured with. Examples of such machine learning models may include, but are not limited to, neural network (NN) models. The UE 104 may be configured to measure one or more channel metrics for one set of resources (e.g., CMRs 410, first set of CMRs 510, first subset of CMRs). The UE 104 may be configured to predict one or more channel metrics for the other set resources (e.g., CPRs, second set of CMRs 514, second subset of CMRs).

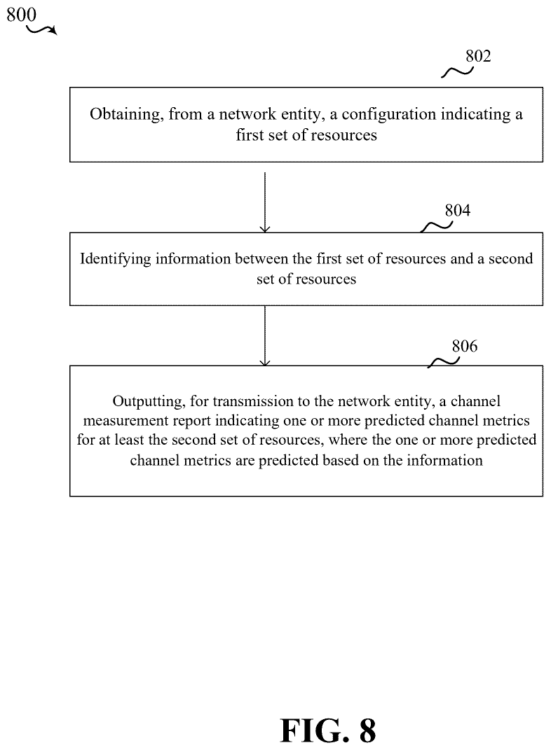

Referring to FIG. 7 and FIG. 8, in operation, UE 104 may perform a method 800 of wireless communication, by such as via execution of Beam Prediction Component 198 by processor 705 and/or memory 360 (FIG. 3). In this case, the processor 705 may be the receive (rx) processor 356, the controller/processor 359, and/or the transmit (tx) processor 368 described above in FIG. 3.

At block 802, the method 800 includes obtaining, from a network entity, a configuration indicating a first set of resources. For example, in an aspect, means for obtaining, from a network entity, configuration indicating a first set of resources may be configured as or may comprise at least one of UE 104, processor 705, memory 360, correspondence information identification component 198, and/or obtaining component 720.

For example, the obtaining at block 802 may include receiving the configuration via a wireless signal at an antenna or antenna array (e.g., antenna 352) as described in FIG. 3.

At block 804, the method 800 includes identifying information between the first set of resources and a second set of resources. For example, in an aspect, means for identifying information between the first set of resources and a second set of resources may be configured as or may comprise at least one of UE 104, processor 705, memory 360, correspondence information identification component 198, and/or identifying component 725.

At block 806, the method 800 includes outputting, for transmission to the network entity, a channel measurement report indicating one or more predicted channel metrics for at least the second set of resources, where the one or more predicted channel metrics are predicted based on the information. For example, in an aspect, means for outputting, for transmission to the network entity, a channel measurement report indicating one or more predicted channel metrics for at least the second set of resources, where the one or more predicted channel metrics are predicted based on the information may be configured as or may comprise at least one of UE 104, processor 705, memory 360, correspondence information identification component 198, and/or identifying component 725.

For example, the outputting at block 710 may include transmitting report via a wireless signal at an antenna or antenna array (e.g., antenna 352) as described in FIG. 3.

In alternative or additional aspect, the resources of the first set are channel measurement resources (CMR) and the resources of the second set are channel prediction resources (CPR).

In alternative or additional aspect, the configuration further indicates the second set of resources.

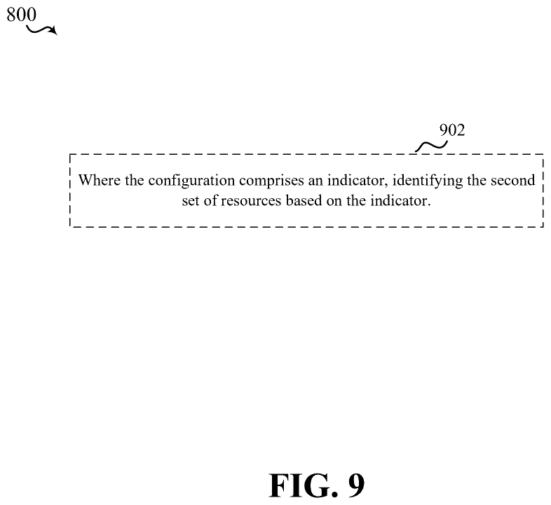

Referring to FIG. 9, in an alternative or additional aspect, at block 902, the configuration may comprise an indicator and the method 800 may further include identifying the second set of resources based on the indicator. For example, in an aspect, means for identifying the second set of resources based on the indicator may be configured as or may comprise at least one of UE 104, processor 705, memory 360, correspondence information identification component 198, and/or identifying component 725.

In alternative or additional aspect, the resources of the first set and the resources of the second set are channel measurement resources (CMRs) and are subsets of a third set of resources.

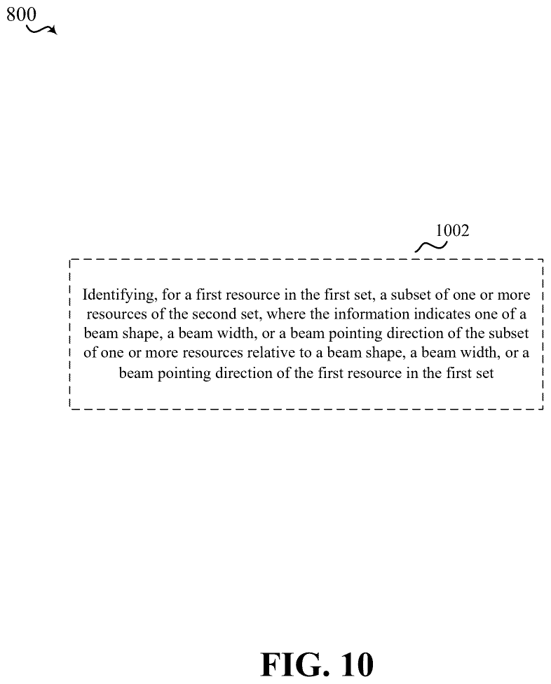

Referring to FIG. 10, in an alternative or additional aspect, at block 1002, the method 800 may further include identifying, for a first resource in the first set, a subset of one or more resources of the second set, where the information indicates one of a beam shape, a beam width, or a beam pointing direction of the subset of one or more resources relative to a beam shape, a beam width, or a beam pointing direction of the first resource in the first set. For example, in an aspect, means for identifying, for a first resource in the first set, a subset of one or more resources of the second set, where the information indicates one of a beam shape, a beam width, or a beam pointing direction of the subset of one or more resources relative to a beam shape, a beam width, or a beam pointing direction of the first resource in the first set, may be configured as or may comprise at least one of UE 104, processor 705, memory 360, correspondence information identification component 198, and/or identifying component 725.

In alternative or additional aspect, the resources of the second set are channel prediction resources, and the one or more resources of the subset are identified based on a set of defined rules indicating an association between the one or more resources of the subset and the first resource in the first set.

In alternative or additional aspect, the subset of one or more resources is identified based on a bitmap.

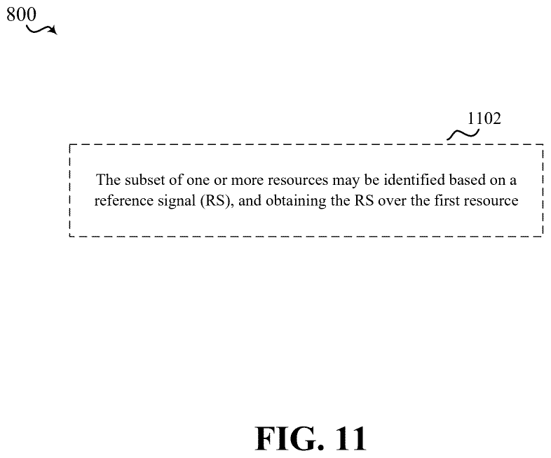

Referring to FIG. 11, in an alternative or additional aspect, at block 1102, the subset of one or more resources may be identified based on a reference signal (RS), and the method 800 may further include obtaining the RS over the first resource. For example, in an aspect, means for obtaining the RS over the first resource may be configured as or may comprise at least one of UE 104, processor 705, memory 360, correspondence information identification component 198, and/or obtaining component 720.

For example, the obtaining at block 1102 may include receiving the RS via a wireless signal at an antenna or antenna array (e.g., antenna 352) as described in FIG. 3.

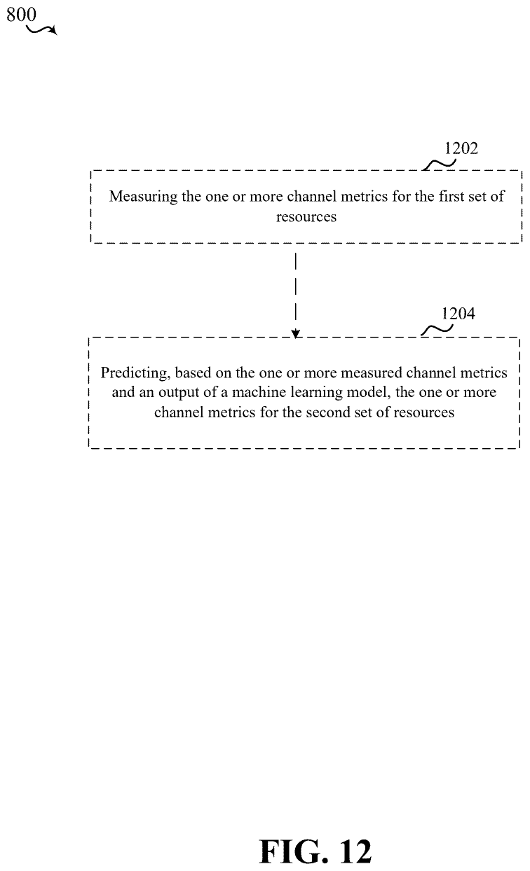

Referring to FIG. 12, in an alternative or additional aspect, at block 1202, the method 800 may further include measuring the one or more channel metrics for the first set of resources. For example, in an aspect, means for measuring the one or more channel metrics for the first set of resources may be configured as or may comprise at least one of UE 104, processor 705, memory 360, correspondence information identification component 198, and/or measuring component 745.

In this optional aspect, at block 1204, the method 800 may further include predicting, based on the one or more measured channel metrics and an output of a machine learning model, the one or more channel metrics for the second set of resources. For example, in an aspect, means for predicting, based on the one or more measured channel metrics and an output of a machine learning model, the one or more channel metrics for the second set of resources may be configured as or may comprise at least one of UE 104, processor 705, memory 360, correspondence information identification component 198, and/or predicting component 750.

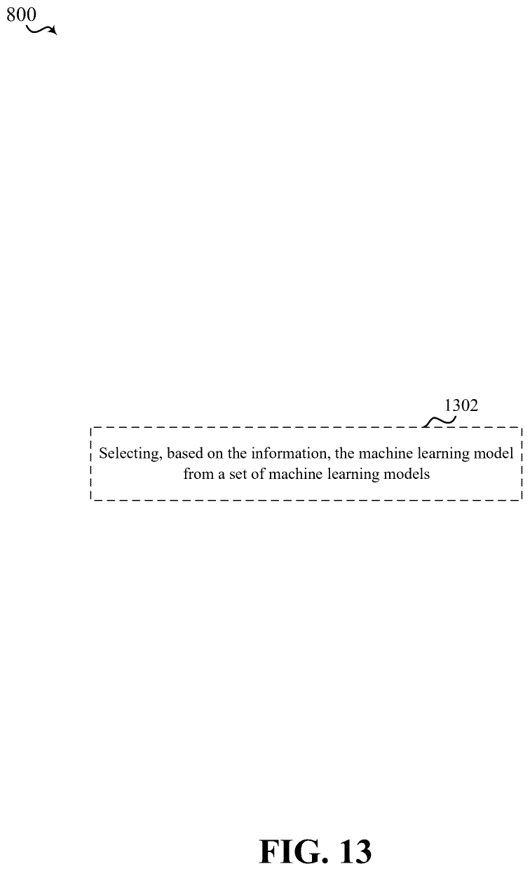

Referring to FIG. 13, in an alternative or additional aspect, at block 1302, the method 800 may further include selecting, based on the information, the machine learning model from a set of machine learning models. For example, in an aspect, means for selecting the machine learning model from a set of machine learning models may be configured as or may comprise at least one of UE 104, processor 705, memory 360, correspondence information identification component 198, and/or selecting component 740.

In alternative or additional aspect, the information indicates at least one of a beam shape, a beam width, or a beam pointing direction of the second set of resources relative to a beam shape, a beam width, or a beam pointing direction of the first set of resources.

In alternative or additional aspect, each of beam widths of some resources of the second set are within a beam width of a resource in the first set.

In alternative or additional aspect, the configuration is associated with at least one of a periodic channel state information (CSI) report, a semi-persistence CSI report, or an aperiodic CSI report

In alternative or additional aspect, the configuration is obtained via a Radio Resource Control (RRC) message, a medium access control (MAC) control element (CE) message, or a downlink control information (DCI) message.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is a method of wireless communication at a user equipment, comprising: obtaining, from a network entity, a configuration indicating a first set of resources; identifying information between the first set of resources and a second set of resources; and outputting, for transmission to the network entity, a channel measurement report indicating one or more predicted channel metrics for at least the second set of resources, wherein the one or more predicted channel metrics are predicted based on the information.

Example 2 is the method of example 1 wherein the resources of the first set are channel measurement resources (CMR) and the resources of the second set are channel prediction resources (CPR).

Example 3 is the method of any of examples 1-2, wherein the configuration further indicates the second set of resources.

Example 4 is the method of any of examples 1-3, wherein the configuration comprises an indicator, and the method further comprises: identifying the second set of resources based on the indicator.

Example 5 is the method of any of examples 1-4, wherein the resources of the first set and the resources of the second set are channel measurement resources (CMRs) and are subsets of a third set of resources.

Example 6 is the method of any of examples 1-5, further comprising: identifying, for a first resource in the first set, a subset of one or more resources of the second set, where the information indicates one of a beam shape, a beam width, or a beam pointing direction of the subset of one or more resources relative to a beam shape, a beam width, or a beam pointing direction of the first resource in the first set.

Example 7 is the method of example 6, wherein: the resources of the second set are channel prediction resources; and the one or more resources of the subset are identified based on a set of defined rules indicating an association between the one or more resources of the subset and the first resource in the first set.

Example 8 is the method of example 6, wherein the subset of one or more resources is identified based on a bitmap.

Example 9 is the method of example 6, wherein the subset of one or more resources is identified based on a reference signal (RS).

Example 10 is the method of example 9, further comprising: obtaining the RS over the first resource.

Example 11 is the method of any of examples 1-10, further comprising: measuring the one or more channel metrics for the first set of resources; and predicting, based on the one or more measured channel metrics and an output of a machine learning model, the one or more channel metrics for the second set of resources.

Example 12 is the method of example 11, further comprising: select, based on the correspondence information, the machine learning model from a set of machine learning models.

Example 13 is the method of any of examples 1-12, wherein the information indicates at least one of a beam shape, a beam width, or a beam pointing direction of the second set of resources relative to a beam shape, a beam width, or a beam pointing direction of the first set of resources.

Example 14 is the method of example 13, wherein each of beam widths of some resources of the second set are within a beam width of a resource in the first set.

Example 15 is the method of any of examples 1-14, wherein the configuration is associated with at least one of a periodic channel state information (CSI) report, a semi-persistence CSI report, or an aperiodic CSI report.

Example 16 is the method of any of examples 1-15, wherein the configuration is obtained via a Radio Resource Control (RRC) message, a medium access control (MAC) control element (CE) message, or a downlink control information (DCI) message.

Example 17 is a user equipment (UE) comprising: a transceiver; a memory comprising instructions; and one or more processors configured to cause the UE to perform a method in accordance with any one of examples 1-16, wherein the transceiver is configured to: receive the configuration; and transmit the channel measurement report.

Example 18 is an apparatus for wireless communications, comprising means for performing a method in accordance with any one of examples 1-16.

Example 19 is a non-transitory computer-readable medium comprising instructions that, when executed by an apparatus, causes the apparatus to perform a method in accordance with any one of examples 1-16.

Example 20 is an apparatus for wireless communications, comprising: a memory comprising instructions; and one or more processors configured to execute the instructions to cause the apparatus to perform a method in accordance with any one of examples 1-16.

What is claimed is:

1. An apparatus configured for wireless communication, comprising:
a memory comprising instructions; and
one or more processors configured to execute the instructions and cause the apparatus to:
obtain, from a network entity, a configuration indicating a first set of resources;
identify information between the first set of resources and a second set of resources; and
output, for transmission to the network entity, a channel measurement report indicating one or more channel metrics for at least the second set of resources, wherein the one or more channel metrics are predicted based on the information.

2. The apparatus of claim 1, wherein the resources of the first set are channel measurement resources (CMR) and the resources of the second set are channel prediction resources (CPR).

3. The apparatus of claim 1, wherein the configuration further indicates the second set of resources.

4. The apparatus of claim 1, wherein the configuration comprises an indicator, and wherein the one or more processors are further configured to cause the apparatus to:
identify the second set of resources based on the indicator.

5. The apparatus of claim 1, wherein the resources of the first set and the resources of the second set are channel measurement resources (CMRs) and are subsets of a third set of resources.

6. The apparatus of claim 1, wherein the one or more processors are further configured to cause the apparatus to:
identify, for a first resource in the first set, a subset of one or more resources of the second set;
wherein the information indicates one of a beam shape, a beam width, or a beam pointing direction of the subset of one or more resources relative to a beam shape, a beam width, or a beam pointing direction of the first resource in the first set.

7. The apparatus of claim 6, wherein:
the resources of the second set are channel prediction resources; and
the one or more resources of the subset are identified based on a set of defined rules indicating an association between the one or more resources of the subset and the first resource in the first set.

8. The apparatus of claim 6, wherein the subset of one or more resources is identified based on a bitmap.

9. The apparatus of claim 6, wherein the subset of one or more resources is identified based on a reference signal (RS).

10. The apparatus of claim 9, wherein the one or more processors are further configured to cause the apparatus to obtain the RS over the first resource.

11. The apparatus of claim 1, wherein the one or more processors are further configured to cause the apparatus to:
measure one or more channel metrics for the first set of resources; and
predict, based on the one or more measured channel metrics and an output of a machine learning model, the one or more channel metrics for the second set of resources.

12. The apparatus of claim 11, wherein the one or more processors are further configured to cause the apparatus to:
select, based on the information, the machine learning model from a set of machine learning models.

13. The apparatus of claim 1, wherein the information indicates at least one of a beam shape, a beam width, or a beam pointing direction of the second set of resources relative to a beam shape, a beam width, or a beam pointing direction of the first set of resources.

14. The apparatus of claim 13, wherein each of beam widths of some resources of the second set are within a beam width of a resource in the first set.

15. The apparatus of claim 1, wherein the configuration is associated with at least one of a periodic channel state information (CSI) report, a semi-persistence CSI report, or an aperiodic CSI report.

16. The apparatus of claim 1, wherein the configuration is obtained via a Radio Resource Control (RRC) message, a medium access control (MAC) control element (CE) message, or a downlink control information (DCI) message.

17. A user equipment (UE), comprising:
a transceiver;
a memory comprising instructions; and
one or more processors configured to execute the instructions and cause the UE to:
receive, via the transceiver and from a network entity, a configuration indicating a first set of resources;
identify information between the first set of resources and a second set of resources; and
transmit, via the transceiver and to the network entity, a channel measurement report indicating one or more predicted channel metrics for at least the second set of resources, wherein the one or more predicted channel metrics are being based on the information.

18. A method of wireless communication at a User Equipment (UE), comprising:
obtaining, from a network entity, a configuration indicating a first set of resources;
identifying information between the first set of resources and a second set of resources; and
outputting, for transmission to the network entity, a channel measurement report indicating one or more channel metrics for at least the second set of resources, wherein the one or more channel metrics are predicted based on the information.

19. The method of claim 18, further comprising:
identifying, for a first resource in the first set, a subset of one or more resources of the second set;
wherein the information indicates one of a beam shape, a beam width, or a beam pointing direction of the subset of one or more resources relative to a beam shape, a beam width, or a beam pointing direction of the first resource in the first set.

20. The method of claim 19, wherein the subset of one or more resources is identified based on a set of defined rules indicating an association between one or more resources of the subset and the first resource in the first set, a bitmap, or a reference signal obtained over the first resource.
